(19) United States
(12) Patent Application Publication
(10) Pub. No.: US 2006/0004593 A1
(43) Pub. Date: Jan. 5, 2006

(54) Method and system for gathering, transporting and marketing offshore oil and gas

(75) Inventors: Steven G. Seat, Cypress, TX (US); William D. Bozeman, Humble, TX (US)

Correspondence Address: HUNTON & WILLIAMS LLP, 1601 BRYAN STREET, ENERGY PLAZA - 30TH FLOOR, DALLAS, TX, 75201, US

(73) Assignee: Devon Energy Corporation

(21) Appl. No.: 10/958,783

(22) Filed: Oct. 4, 2004

Related U.S. Application Data
(60) Provisional application No. 60/583,977, filed on Jun. 30, 2004.

(51) Int. Cl. G06F 17/60

(52) U.S. Cl. 705/1

(57) ABSTRACT

A method has been provided for gathering, transporting, and marketing hydrocarbons from offshore fields. The method can include gathering different quality oils and then storing and/or segregating the oils according to such qualities. The oils can then be marketed, according to the qualities, to one or more locations via a floating vessel. In some configurations, the method can further include a gathering of gas and then processing of at least a portion of the gathered gas on the vessel. Gas processing techniques can include, among others, a compression of the gas, a generation of electricity, an internal utilization on the vessel, and a gas-to-liquids processing. The product of some of the processing techniques can, in turn, be marketed to one or more locations.

### CROSS-REFERENCE TO RELATED APPLICATIONS

Pursuant to 35 U.S.C. § 119(e), this Application claims the benefit of and hereby incorporates by reference for all purposes U.S. Provisional Patent Application Ser. No. 60/583,977 entitled Method and System for Gathering, Transporting and Marketing Offshore Oil and Gas, naming Steven G. Seat and William D. Bozeman as inventors, filed Jun. 30, 2004.

### TECHNICAL FIELD OF THE INVENTION

The present invention relates generally to the field of petroleum production and more particularly, but not by way of limitation, to a method and system for gathering, transporting, and marketing offshore oil and gas from multiple fields and multiple operators.

### BACKGROUND OF THE INVENTION

The advancement of offshore drilling and production technology has afforded the petroleum industry the capability to seek production in various areas of the world—such areas including, among others, deepwater environments and previously unexplored underwater production fields. With such production, concern lies with the transportation of petroleum products to onshore locations. A traditional transportation method involves the utilization of large seabed oil or gas pipelines that commingle the production from several vessels, production platforms, or the like (which may be associated with one or more different underwater fields) to deliver to a central location onshore or at a central delivery point. One difficulty that arises with such pipelines or trunklines is the simple fact that production, which may be of varying qualities, must be “commingled” in the pipeline. Such a commingling is often undesirable—particularly in circumstances where an operator seeks to segregate their product from other products or does not wish to pay an added tariff or fee because the quality of their production may not meet certain standards. For example, when a particular development or field produces a high quality oil, an operator may not want to commingle such high quality oil with various lower qualities of oil. Such a commingling, in a sense, dilutes the high quality oil and can hurt a potential market price for the higher quality oil.

Another concern arises with associated gas that is often produced along with the production of oil. Such gas is often difficult to market economically. Production facilities may attempt to flare the gas; however, regulations in many countries or regions prohibit or greatly restrict such flaring. Gas reinjection is another alternative, but can be very expensive. Therefore, production vessels, production platforms, or the like have the associated gas transported to a sales point via seabed trunklines—typically one seabed trunkline exists for gas and one seabed trunkline exists for oil. In order to enable the transportation to such gas trunklines, the gas needs to be compressed to a sufficient pressure. Flow assurance and operational problems due to low flow rates can result in the associated gas handling costs being higher than the sales value of the gas. The capital cost to install such systems and pipelines can be cost prohibitive, including the capital and operating costs of gas compressors to provide the associated gas at desired or required gas pipeline pressures.

Other problems that arise with the use of such trunklines involve the location of a particular development. For example, when production begins in a new development area, especially at an underwater shelf or transition point where underwater depths increase substantially, seabed trunklines may not exist nearby. Therefore, in order for a production vessel or platform to connect to such seabed trunklines, connection pipeline must be laid. Depending on the distance involved, the installation of pipelines can become cost prohibitive, rendering the fields uneconomical. And, a further exacerbation arises in deepwater production environments. An increase in water depth typically increases the cost/unit length of pipeline being laid, and increases the need for larger pipe to support the increased production requirements of such deepwater fields to justify the tougher economic constraints because of the increased capital and operating costs required of such deepwater fields.

Other problems involve pipeline installation difficulties that can occur in pipelines placed in non-ideal environments—e.g., seabeds that are rough or inclined and seabeds with caverns and canyons.

Further concerns involve fees associated with an operator's use of such pipelines or trunklines. That is, an operator must pay a “transportation fee” to have their product transported to shore. Additional pipeline transportation fees are almost always encountered in transporting oil to a desired delivery point.

### SUMMARY OF THE INVENTION

From the foregoing it may be appreciated that a need has arisen for a method and system for gathering, transporting, and marketing offshore oil and gas from multiple fields that are operated by multiple operators. In accordance with the present invention, a method and system for gathering, transporting, and marketing offshore oil and gas is provided that substantially eliminate one or more of the disadvantages and problems outlined above.

According to an aspect of the present invention, a method involving hydrocarbons from offshore fields has been provided. The method comprises gathering a first quality oil defined by a first quality and a second quality oil defined by a second quality at a vessel that includes a storage volume; storing at least a portion of the first quality oil in a first compartment of the storage volume of the vessel; storing at least a portion of the second quality oil in a second compartment of the storage volume of the vessel; and transporting at least a portion of the first quality oil stored in the first compartment of the storage volume of the vessel to at least a first location via a floating vessel.

This aspect of the invention, among other features, can further include marketing at least a portion of the first quality oil, according to the first quality and marketing at least a portion of the second quality oil, according to the second quality; mixing at least a portion of the first quality oil and at least a portion of the second quality oil to form a third quality oil and storing at least a portion of the third quality oil in a third compartment of the storage volume of the vessel; gathering gas at the vessel; processing at least a portion of gas that is gathered at the vessel; gathering the first quality oil from a plurality of locations; measuring a quantity and a quality of the at least a portion of the first quality oil and measuring a quantity and a quality of the at least a portion of the second quality oil; the vessel being an FSOG vessel; and the vessel being a floating platform.

According to another aspect of the present invention, a method involving hydrocarbons from offshore fields has been provided. The method comprises receiving oil and gas at a first production platform from a first underwater development; receiving oil and gas at a second production platform from a second underwater development; processing oil at the first production platform to produce a first quality oil; processing oil at the second production platform to produce a second quality oil; gathering the first quality oil and the second quality oil at a vessel that includes a storage volume; gathering the gas from the first production platform at the vessel; processing at least a portion of the gas at the vessel; and transporting at least a portion of the first quality oil and the second quality oil stored in the storage volume to a first location using a floating vessel.

This aspect of the invention, among other features, can further include utilizing at least a portion of the gas to generate power; marketing at least a portion of generated power to at least one operator; utilizing at least a portion of generated power for at least one system of the vessel; utilizing at least a portion of the generated power to heat at least one of the first quality oil and the second quality oil stored at the vessel; utilizing at least a portion of the generated power to generate steam; compressing at least a portion of the gas; and processing at least a portion of the gas with a gas-to-liquids process.

The various embodiments and implementations of the present invention provide a profusion of potential technical advantages and benefits. A technical advantage of the present invention may include the capability to allow a maximum value to be realized for various oil qualities or characteristics that are produced from multiple oil fields.

Another technical advantage of the present invention may include the capability to deliver processed oils to a plurality of different locations.

Yet another technical advantage of the present invention may include the capability to reduce oil transportation costs.

Still yet another technical advantage of the present invention may include the capability to reduce the costs of handling and marketing associated gas from individual fields by combining the gas production from such fields, thereby allowing higher volumes to be available for gas utilization processes, including sales, gas to liquids, power generation or other gas utilization strategies.

Still yet another technical advantage of the present invention may include the capability to quickly allow an operator to bring a newly discovered oil field on line by minimizing pipeline lengths and thus minimizing compressor and pumping requirements associated with larger and/or longer pipelines.

Yet another technical advantage of the present invention may include the capability to transform previously uneconomical deepwater production fields into economically viable locations for gathering, transporting and marketing oil and gas.

Yet another technical advantage of the present invention may include the capability to provide electricity to other production platforms, or to deliver electric power onshore based on the use of generators powered by associated gas.

Other technical advantages may be readily apparent to one skilled in the art after review of the following figures and description, associated herewith.

### BRIEF DESCRIPTION OF THE DRAWINGS

For a more complete understanding of the present invention and the advantages thereof, reference is now made to the following brief description, taken in connection with the accompanying drawings and detailed description, wherein like reference numerals represent like parts, in which:

FIG. 1 is a perspective view of an exemplary structure that can be utilized with the process and system described herein;

FIG. 2 is a side perspective view of the exemplary structure of FIG. 1, illustrating the segregation of multiple hydrocarbon products;

FIG. 3 is an exemplary process flow diagram for handling of oil; and

FIG. 4 is an exemplary process flow diagram for handling of gas.

### DETAILED DESCRIPTION OF THE INVENTION

It should be understood at the outset that although an exemplary implementation of the present invention is illustrated below, the present invention may be implemented using any number of techniques, whether currently known or in existence. The present invention should in no way be limited to the exemplary implementations, drawings, and techniques illustrated below, including the exemplary design and implementations illustrated and described herein. Additionally, the drawings contained herein are not necessarily drawn to scale.

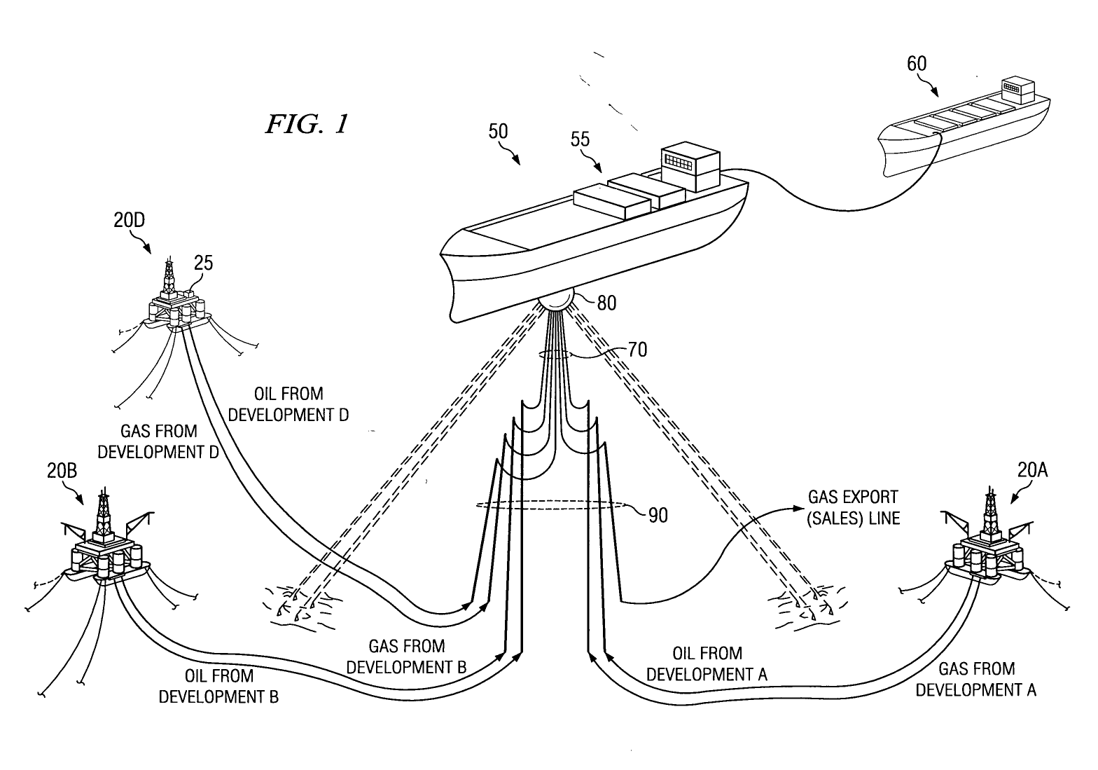

FIGS. 1-4 are generally illustrative of a process and system that can be utilized to gather and market processed hydrocarbons from various hydrocarbon field developments operated by various oil companies, including deepwater field developments. While an exemplary structural configuration will be described in reference to such a process, it should be expressly understood that such an operation is not limited to such configurations. Other configurations can be utilized, including not only those now known, but also those that will be later developed.

In the offshore production of hydrocarbons, a production facility—e.g. a platform, floating production system or vessel (dynamically positioned or moored), or the like—can generally produce and/or store hydrocarbons obtained from one or more hydrocarbon fields/developments. Various technologies, facilities, and configurations exist to extract, store, and process these hydrocarbons. The process described herein is not limited to any one of these technologies, but rather intends to avail itself of any extraction, and processing techniques/configurations—whether such techniques/configurations are currently known or developed in the future. The processing of hydrocarbons by any operator onboard their own platform or floating production vessel (semi, spar, etc.) can allow certain benefits, including, but not limited to ensuring that all production departing a particular operator's facilities meets certain operator specifications (e.g., water content and other impurities). After such production, the processed (dry) crude and (dry) associated gas can then be transported (e.g., utilizing pumps or the like) to a Floating oil Storage and Offloading vessel with Gas utilization capabilities (FSOG vessel) 50.

As the oil from a particular field, development, or operator may have a particular quality or characteristic (for example, an operator may have chosen a particular field for its characteristics), it may be desirable to independently transport and market such oil—that is, to keep such oil from each field, development, or operator separated. As such, the oil and gas from a particular development can be transported in separate lines to the FSOG vessel 50. FIG. 1 illustrates such an example, showing independent oil and gas lines from developments A, B, and D. While a variety of different devices can be utilized to facilitate the independent transport of product from storage/production facilities, for the sake of simplicity, only the transport lines extending from such developments are shown. Thus, it should be expressly understood that any transportation techniques, either now known or developed in the future, can be utilized. While lines are shown extending from three independent developments A, B, and D, independent lines could also extend from the same development (e.g., development A) where there is a general desire to keep the products in separate lines. In such a configuration, it should be recognized by one of ordinary skill in the art that single structures exist that can house two or more independent lines. While different independent lines have been shown, it should be understood that some of these lines could be production that is commingled with production from other fields or operators (e.g., either in an operator's pipelines or onboard the operator's facility). To a certain degree, the degree of separation of these different products will be determinate upon a desire to keep products separate and/or a preference of the operator. More details of benefits of separation will be described in further detail below.

FIG. 1 illustrates one configuration of the transporting of the independently separated products on the seabed from an endpoint of the oil and gas lines A, B, and D (e.g., from independently operated developments) to the FSOG vessel 50. For illustrative purposes only, developments A, B, and D have been shown with corresponding platforms 20A, 20B, and 20D with oil and gas lines A, B, and D, extending therefrom.

In the configuration of FIG. 1, a set of top-tensioned risers 90 (one riser 90 connected to one or more product lines) is shown extending from the seabed to the general location of a set of cans or buoys (not shown, but generally recognized by those in the art as facilitating the interface between the top of the riser 90 and a jumper 70). Such risers 90 as will be recognized by one of ordinary skill in the art can either be individual or multiple risers joined together. The maintenance of bottom tension for the riser 90 can be accomplished utilizing a variety of mooring techniques (e.g., suction piles—not shown) while the maintenance of the top tension for the risers 90 utilizes the buoyancy of the cans or buoys. From the top of the risers 90 (the general location of the set of cans or buoys), the product is then transported to a turret 80 on the FSOG vessel 50 via a set of jumpers or flexible hoses 70 (one jumper or flexible hose 70 connected to each riser, which in turn is connected to each product line). In this transport, each product can maintain independent fluid communication from the product line (e.g., oil or gas line A, B, or D) through the riser 90, through the flexible hose 70, and on to the turret 80. The turret 80 can be an internal or external turret; and, the FSOG vessel 50 can generally be arranged and designed to weathervane about the turret 80. Furthermore, the FSOG vessel 50 can be equipped with devices which facilitate the response of vessels to environmental conditions (e.g., responsive to motions of heave, pitch, roll, and the like), including such devices and configurations that are now known and those that will be later developed. Further, generally any design for the turret 50 can be utilized, including those known and those later developed.

The oil and gas products (e.g., in the independent lines) arriving at the FSOG vessel 50 can be metered and measured for quantity and quality. The metering at the point of arrival allows different qualities of product to be shipped down a particular line (e.g., at different time intervals). To this end, the lines in some configurations can be piggable.

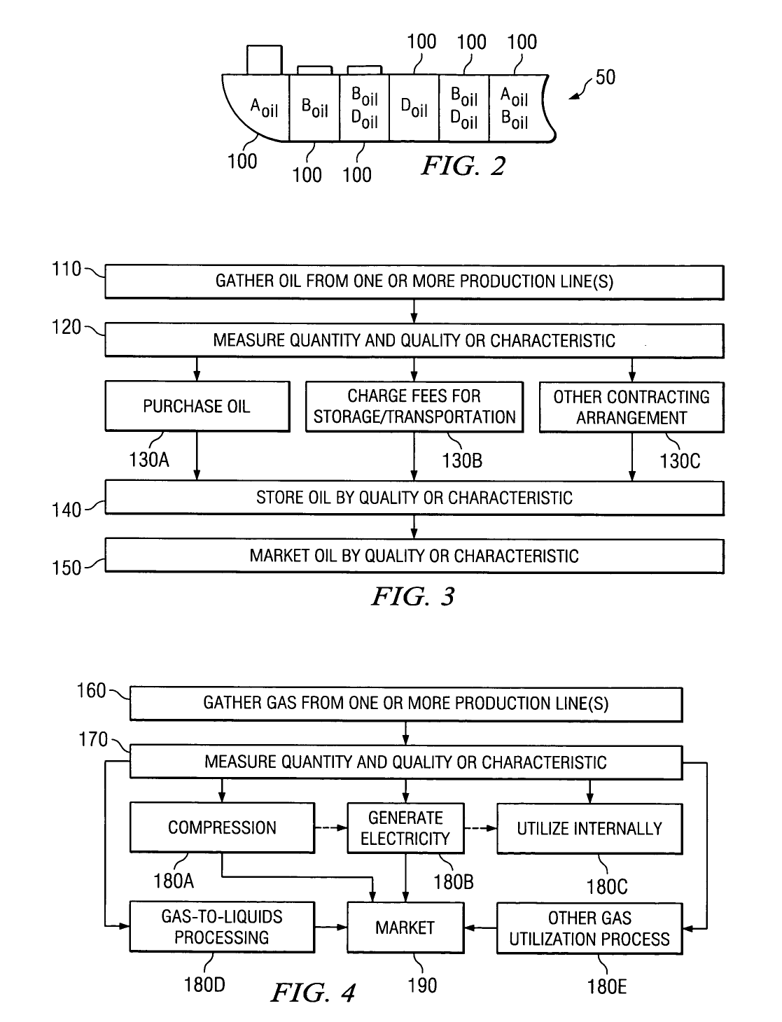

After metering and measuring, the oil can be stored and transported to shore using shuttle tankers 60 or the like and, in some situations, using the above-referenced sea bed trunklines. The oil that is received and stored on the FSOG vessel 50 can be commingled with other oil or the oil can be stored in separate tanks depending on quantity and quality (e.g., by sulfur content, API gravity, and the like). As an example, with reference to FIG. 2, six tanks 100 are shown in an FSOG vessel 50 with three being used to store oil separately and three being used to store commingled oil.

Prior to the storage tanks becoming full, the oil can be offloaded (e.g., through pumping or the like) through a (floating) hose off the stern of the FSOG vessel 50 to a shuttle tanker 60 (dynamic positioned or connected with a hawser). The shuttle tanker 60 (FIG. 1), when filled, can disconnect from the FSOG vessel 50 and proceed to a refinery or port for offloading (sales) and/or to another storage tanker/vessel.

As the oil from various fields with different quality or characteristics can be stored separately on the FSOG vessel 50, an operator can not only select a preferred sales point to obtain the maximum sales price (e.g., spot marketing the oil), but can also choose to market the oil in a variety of locations—e.g., including but not limited to refineries and/or a variety of hydrocarbon processing and/or plastic production facilities. In addition, separate storage on the FSOG vessel 50 allows oil from certain operators or fields to be stored and sold separately—e.g., as referenced above, allowing an operator to know that all production produced from a certain operator and then maintained in a separate tank has met certain operator specifications. The operator of the FSOG vessel 50 additionally can have the option of (1) purchasing the oil from the other operators as the oil enters the FSOG vessel 50 and then later selling the oil at a preferred sales point, (2) charging a fee or tariff to store and transport the oil to sales points determined by other operators, or (3) facilitating other contracting arrangements that take advantage of the ability to segregate the oil and transport it to specific sales locations.

The transportation of gas to the FSOG vessel 50 has benefits, within itself. As referenced above, associated gas in certain circumstances can be considered uneconomical. For example, in some systems, very high pressure may be required to transport the product long distances to a seabed trunkline—e.g., the pressure of the gas must be higher than the pressure in the seabed trunkline. As the gas product can be transported a shorter distance to the FSOG vessel 50, less pressure may be required. Additionally, the gathering of gas from several sources creates value in the gas.

After metering and measuring on the FSOG vessel 50, the gas can enter a gas utilization process—e.g., such processes including, but not limited to: 1) gas compression and sales through an export pipeline to an existing trunkline; 2) gas compression and sales through an export pipeline to shore; 3) utilization of the gas as fuel gas on the FSOG vessel 50 for power generation and/or steam generation for ship systems and heat in the oil storage tanks; 4) gas-to-liquids processing on the FSOG vessel 50 to convert the gas into liquid hydrocarbons that can either be blended with the oil or stored and sold separately as more valuable products (diesel, naphtha, etc); and 5) generation of power (e.g., electricity) to sell to other operators that are producing the oil and gas (e.g., other platforms, production vessels, and the like). To facilitate these processes, gas utilization/process equipment 55 can be located on the main deck.

Thus, the FSOG vessel 50 of this process and system can serve as a multi-faceted hub, capable of interacting with one or more production platforms and/or vessels to facilitate transportation and/or marketing. As an example, intended for illustrative purposes only, an FSOG vessel 50 can be positioned in a strategic location (e.g., via mooring or dynamic positioning) between one or more production vessels, production platforms, or the like. As will be appreciated by one of ordinary skill in the art, the time to bring the FSOG vessel 50 online (e.g., receiving production from the production vessels, production platforms, or the like) is relatively short compared to current alternatives—namely, the laying of long deepwater pipelines to connect to a trunkline. Production vessels, production platforms, or the like that connect with the FSOG vessels 50 can benefit in that they can completely avoid connection to a trunkline, which as noted above, can be unavailable in some circumstances (e.g., a field may just have been discovered). And, the production vessel, production platform, or the like can have a convenient location to transport their gas—once again, in some circumstances, reducing pressurizations. Further, the production vessel, production platform, or the like can purchase their electricity from the FSOG vessel 50 for operation—reducing the need (in certain circumstances) for the production vessel to have large power generation facilities thereon. Even further, the FSOG vessel 50 can reduce or eliminate a need for compressors that may be needed on a production vessel, production platform, or the like to transport gas away from the production vessel, production platform, or the like. With regards to the last two aspects and for illustrative purposes only, such compressors and power generation facilities are generally described as being located at a location 25 e.g., on production platform 20D. The benefits of a reduction/removal of such compressors/power generation facilities (e.g., located at a location 25) should become apparent to one of ordinary skill in the art.

Additionally, the FSOG vessel 50 can segregate in a variety of different manners production from certain developments, fields, operators, or productions vessels, production platforms, or the like—advantageously allowing the sale and/or marketing of such segregated product.

It should be understood that the process described herein, while describing a specific FSOG vessel 50, can utilize generally any storage structure (e.g., barge or the like) that can generally be adapted to accept product from production. Such adaptations can generally include any currently known techniques as well as others that will be developed in the future. Other contemplated storage structures include floating platforms with storage space that can be floated on site and moored or dynamically positioned in a strategic location. In a manner similar to that described above, the hulls can be compartmentalized and utilize various ballasting techniques that will become apparent to those skilled in the art. Additionally, it should be understood that the process and structures described herein are scalable. For example, one or more FSOG vessels 50 or the like can be utilized to take advantage of potentially high production loads. When production in an area increases, more FSOG vessels 50 can be brought on site.

FIGS. 3 and 4 are exemplary generalizations of the process described herein—FIG. 3 corresponding to a handling of oil and FIG. 4 corresponding to a handling of gas. FIG. 3 at a step 110 can include the general gathering of oil from one or more product lines from various production facilities. Once again, various techniques can be utilized to accomplish such a process. At step 120 the oil can be measured for quantity and characteristic or quality. At least three alternatives can occur at steps 130A, 130B, and 130C: the oil can be purchased (130A), a fee can be charged to the operator for storage and transportation (130B), or other contracting arrangements can be utilized (130C) that take advantage of segregation. At step 140 the oil can be stored by characteristic or quality. These characteristics can be a complete segregation as described above or a characteristic that is defined by a commingling of products or products. Other manners of “characterizing” the oil were described above; and, others should become apparent to one of ordinary skill in the art. At step 150, the oil can be marketed. This marketing can involve, among other marketing techniques, “spot marketing” or long term contract sales to various locations.

FIG. 4 can include at a step 160 the general gathering of gas from one or more product lines. A variety of techniques can be utilized to facilitate this process. At step 170 the gas can be measured for quantity and characteristic or quality. The gas can then be processed at alternative steps of 180A, 180B, 180C, 180D, 180E, which include among other potential steps: compression (180A), utilization to generate electricity (180B), utilizing internally (180C), gas-to-liquids processing (180D) or other gas utilization processes (180E). It will be recognized by one of ordinary skill in the art that some of these alternative steps can overlap to a certain extent. As an example, intended for illustrative purposes only, compression (180A) can occur, whereupon the gas can be utilized to generate electricity (180B), whereupon the gas-generated electricity can then be utilized internally (180C). At a step 190, the product can then be marketed (in whatever form in may be in at that point—e.g., gas, liquid, or electricity) in a variety of manners, including not only those that were described above, but also in other manners that will become apparent to one of ordinary skill in the art.

Thus, it is apparent that there has been provided, in accordance with the present invention, a method and system for gathering, transporting, and marketing offshore oil and gas that satisfies one or more of the advantages set forth above. Although the preferred embodiment has been described in detail, it should be understood that various changes, substitutions, and alterations can be made herein without departing from the scope of the present invention, even if all of the advantages and benefits identified above are not present. For example, the various elements or components may be combined or integrated in another system or certain features may not be implemented. Also, the techniques, systems, sub-systems, and methods described and illustrated in the preferred embodiment as discrete or separate may be combined or integrated with other systems, techniques, or methods without departing from the scope of the present invention. For example, other vessels can be utilized in place of the FSOG 50. Other examples of changes, substitutions, and alterations are readily ascertainable by one skilled in the art and could be made without departing from the spirit and scope of the present invention.

What is claimed is:

1. A method involving hydrocarbons from offshore fields, the method comprising:
gathering a first quality oil defined by a first quality and a second quality oil defined by a second quality at a vessel that includes a storage volume;
storing at least a portion of the first quality oil in a first compartment of the storage volume of the vessel;
storing at least a portion of the second quality oil in a second compartment of the storage volume of the vessel; and
transporting at least a portion of the first quality oil stored in the first compartment of the storage volume of the vessel to at least a first location via a floating vessel.

2. The method of claim 1, wherein the at least a portion of the first quality oil is transported to a plurality of locations.

3. The method of claim 1, further comprising:
marketing at least a portion of the first quality oil, according to the first quality; and
marketing at least a portion of the second quality oil, according to the second quality.

4. The method of claim 1, wherein the first quality oil is gathered from a plurality of locations.

5. The method of claim 1, further comprising:
mixing at least a portion of the first quality oil and at least a portion of the second quality oil to form a third quality oil, and
storing at least a portion of the third quality oil in a third compartment of the storage volume of the vessel.

6. The method of claim 1, further comprising:
receiving oil and gas at a first production platform from a first underwater development;
receiving oil and gas at a second production platform from a second underwater development;
processing oil at the first production platform to produce at least a portion of the first quality oil;
processing oil at the second production platform to produce at least a portion of the second quality oil;
transporting the at least a portion of the first quality oil produced from the first production platform and the at least a portion of the second quality oil produced from the second production platform to the vessel.

7. The method of claim 6, wherein the first underwater development and the second underwater development are part of the same geologic formation.

8. The method of claim 6, further comprising:
measuring a quantity and a quality of the at least a portion of the first quality oil produced from the first production platform; and
measuring a quantity and a quality of the at least a portion of the second quality oil produced from the second production platform.

9. The method of claim 6, further comprising:
gathering gas at the vessel, wherein
at least a portion of the gathered gas is from the first production platform and at least a portion of the gathered gas is from the second production platform.

10. The method of claim 9, further comprising:
compressing the gathered gas; and
transporting the gathered gas to an underwater gas pipeline.

11. The method of claim 1, further comprising:
gathering gas at the vessel.

12. The method of claim 11, wherein the gas is gathered from a plurality of locations.

13. The method of claim 11, further comprising:
processing at least a portion of the gas at the vessel.

14. The method of claim 13, wherein the processing of the gas includes utilizing at least a portion of the gas to generate power.

15. The method of claim 14, further comprising:
marketing at least a portion of the generated power to at least one operator.

16. The method of claim 15, wherein at least a portion of one of the first quality oil and the second quality oil is gathered from the at least one operator.

17. The method of claim 14, wherein at least a portion of the generated power is utilized for at least one system of the vessel.

18. The method of claim 14, wherein at least a portion of the generated power is utilized to heat at least one of the first quality oil and the second quality oil stored on the vessel.

19. The method of claim 14, wherein at least a portion of the generated power is utilized to generate steam.

20. The method of claim 13, wherein the processing of the gas includes compressing at least a portion of the gas.

21. The method of claim 20, further comprising:
marketing the compressed gas.

22. The method of claim 21, wherein at least a portion of the marketing of the compressed gas is via an export pipeline to shore.

23. The method of claim 13, wherein the processing of the gas includes processing at least a portion of the gas with a gas-to-liquids process.

24. The method of claim 23, further comprising:
marketing the liquids produced from the gas-to-liquids process.

25. The method of claim 1, wherein the at least a first location is a refinery.

26. The method of claim 1, wherein the at least a first location is a spot market hub.

27. The method of claim 1, further comprising:
transporting at least a portion of the second quality oil stored in the second compartment of the storage volume of the vessel to a second location via a second floating vessel.

28. The method of claim 1, wherein the vessel is an FSOG vessel.

29. The method of claim 1, wherein the vessel is a floating platform.

30. The method of claim 1, wherein the first quality oil is gathered from a plurality of locations, the method further comprising:
marketing at least a portion of the first quality oil, according to the first quality;
marketing at least a portion of the second quality oil, according to the second quality;
gathering gas from a plurality of locations; and
processing at least a portion of the gas at the vessel.

31. A method involving hydrocarbons from offshore fields, the method comprising:
receiving oil and gas at a first production platform from a first underwater development;
receiving oil and gas at a second production platform from a second underwater development;
processing oil at the first production platform to produce a first quality oil;
processing oil at the second production platform to produce a second quality oil;
gathering the first quality oil and the second quality oil at a vessel that includes a storage volume;
gathering the gas from the first production platform at the vessel;
processing at least a portion of the gas at the vessel; and
transporting at least a portion of the first quality oil and the second quality oil stored in the storage volume to at least a first location using a floating vessel.

32. The method of claim 31, wherein the processing of the gas includes utilizing at least a portion of the gas to generate power.

33. The method of claim 32, further comprising:
marketing at least a portion of the generated power to at least one operator.

34. The method of claim 33, wherein at least a portion of one of the first quality oil and the second quality oil is gathered from the at least one operator.

35. The method of claim 32, wherein at least a portion of the generated power is utilized for at least one system of the vessel.

36. The method of claim 32, wherein at least a portion of the generated power is utilized to heat at least one of the first quality oil and the second quality oil stored at the vessel.

37. The method of claim 32, wherein at least a portion of the generated power is utilized to generate steam.

38. The method of claim 31, wherein the processing of the gas includes compressing at least a portion of the gas.

39. The method of claim 38, further comprising:
marketing the compressed gas.

40. The method of claim 39, wherein at least a portion of the marketing of the compressed gas is via an export pipeline to shore.

41. The method of claim 31, wherein the processing of the gas includes processing at least a portion of the gas with a gas-to-liquids process.

42. The method of claim 41, further comprising:
marketing the liquids produced from the gas-to-liquids process.

43. The method of claim 31, wherein the at least a first location is a refinery.

44. The method of claim 31, wherein the at least a first location is a spot market hub.

45. The method of claim 31, wherein the first quality oil and the second quality oil are gathered from a plurality of locations.

46. The method of claim 31, further comprising:
transporting at least a portion of the first quality oil and the second quality oil stored in the storage volume to a second location via a second floating vessel.

47. The method of claim 31, wherein the vessel is an FSOG vessel.

48. The method of claim 31, wherein the vessel is a floating platform.
